(19) United States
(12) Patent Application Publication
(10) Pub. No.: US 2004/0244597 A1
(43) Pub. Date: Dec. 9, 2004

(54) Riddling/remuage machine

(76) Inventors: Oleg Naljotov, Brooklyn, NY (US); Valery Rudenko, Brooklyn, NY (US)

Correspondence Address: OLEG NALJOTOV, 3130 Brighton 6 Street, APT#5D, BROOKLYN, NY, 11235, US

(21) Appl. No.: 10/453,074

(22) Filed: Jun. 3, 2003

(51) Int. Cl. A23L 1/00

(52) U.S. Cl. 99/275

(57) ABSTRACT

The offered engineering solution (technology) belongs to the food industry —particularly, to the wine industry —and can be used for riddling (dead yeast cells are accumulated in the neck of the bottle) during champagne production (wine production according to the champagne method). The Equipment allows maintaining the equal slant angle for the large number of wine bottles during their repeated revolving. The Equipment has a frame and at least one revolving platform for bottles; moreover, the platform is designed in the form of a disc with holes. Every hole holds a case for a bottle. The Equipment production and exploitation are not difficult, it is reliable, has a great productivity, and guarantees the control of riddling in every bottle at any process stage.

### SUMMARY OF THE INVENTION

The offered engineering solution (technology) belongs to the food industry —particularly, to the wine industry —and can be used for riddling (dead yeast cells are accumulated in the neck of the bottle) during production of classical champagne. In most countries which have wine industry riddling is fulfilled by hand (manually): wine bottles are placed at angle in particular (special) holders and revolved discretely (every bottle) on their axis within 40-50 days (http://www.champagne-ayala.fr/fabrication_eng.html#top).

There are known riddling equipments for champagne which consist of basis with a stage and operating system. The platform can revolve on the axis and is designed for the container with bottles can be put on it (see French patents No 2473356, 1980, and No 8000891, 1981, classification C12G 1/06). These devices are labor-consuming, consist of many complex hinged joints and bearing units. Because the container with bottles weighs too much, high power-consuming engine are required.

However, all these complications make the plant bulky, metal- and power-consuming. The declared invention purposes reducing of metal- and power-consuming, enhancing of operating reliability and convenience, and guaranteeing the possibility to control the riddling process at any stage without break.

This can be achieved as follows: the riddling equipment for champagne consists of a frame with at least one platform on it which can revolve and an operating system which has a placed on the platform engine. A container for bottles can be put on this platform. According to the invention the platform is designed as two discs with holes; the discs are linked by a rod and installed on the frame; the holes are allocated on the discs area evenly, and every hole has a personal container for a bottle which is designed as an open case with a ring on the open end. The operating system consists of a rope connected to the rod and the engine's roller what maintains to-and-fro motion of the rod during the roller reversing rotation.

FIG. 1 shows the assembled representation of the riddling equipment for champagne;

FIG. 2 shows the side representation of the Equipment;

FIG. 3 and FIG. 4 show the different stages of the operating mode;

FIG. 5a, b show the case with a bottle with two foreshortening;

FIG. 6 shows the case without a bottle;

FIG. 7 shows the case modification which is designed as a cover;

FIG. 8 shows the disc construction designed for the great number of bottles. For simplicity every disc is shown only with one case with a bottle.

The equipment has a frame (1), discs (2, 3) placed on the frame, a connecting rod (4). For the additional resistance of the construction the discs can be pinned together with several bolts (5). The discs have holes (6). Every hole has a bottle case (7) and the ring (8). Bottles (9) are placed into cases. The rings (8) are designed in order a case with a bottle could not fall out of the hole and for the bottle can revolve during the disc turns as there is frictional connection between a case and a disc. The following things are fixed on the frame: an engine (10) on one side and a sheave (11) on the other side. There is a rope (12) that is put on the sheave and the engine's roller. The rope ends are fastened to the rod (4) opposite sides with the bearing (13) help which (bearing) is placed on the rod. Besides, the rope is winded round the engine several times.

The equipment operates as follows: on the beginning the disc are on one end of the frame. Every bottle (9) is placed with the neck down in a case (7), which is located in the hole (6) of the discs (3) and (4). The greater part of the bottle is placed in the case. As the case diameter is less than the hole diameter, so the bottles are placed at a particular angle. The angle value depends on the diameters proportions and the discs (3 and 4) thickness. The ring (8) prevent the case with a bottle from falling out of the disc (6) hole.

Then the electric engine (10) is turned on, and its roller begins to revolve. During the revolving the roller rewinds the rope (12) from one side to the other, and consequently draws the rod (4) and discs (3 and 4) with bottles with the help of the bearing (13). The bearing is necessary in order the rope does not wind on the rod. The discs begin to roll (revolve) along the frame (1), and the cases (7) with the inserted bottles (9) also begin to revolve keeping the slant (inclined) position. The ring of every case and the edge of the corresponding hole are such a reducer thanks to which the cases with the bottles revolve every on its axis with equal angular velocity; but this velocity is quicker than the discs revolving velocity (when the disc makes one turn, all the bottles make 1.25 turn on their axis, and even more —it depends on the hole and case diameters proportions). During one working cycle the discs shift from one frame end to the other —this distance facilitates the discs 80-90 degrees rotation, and the engine stops operating. During this process the bottles will revolve on their axes 90-100 degrees, and the dead yeast cells will move into the neck. In several hours the engine will turn on with reversion, and the rope will move the discs to the initial position. So, the bottles will revolve again, and this movement will make the dead yeast cells shift into the bottle necks. Thus, the engine is turned on and off with reversion in certain time intervals, that leads to the dead yeast cells moving into the bottles necks. For the engine commutation a programmed timer can be used. When the riddling process is finished, the bottles are moved out of the cases and sent to undergo the next technological process —disgorge.

The cases can be produced in the form of transparent glasses with thin walls, or plastic covers which will have the bottle shape and notches (cutouts). In order the to prevent the cases without the bottles from falling out of the holes, there could be designed a ferrule on the end of the case (it is not shown at figures).

The disc diameters can be arbitrarily big (FIG. 8) in order the discs can hold a many bottles as possible. To guarantee the necessary slant angle for bottles the disc should be thin enough (5 mm). If the disc thickness is more than 5 mm, then the hole should be cone-shaped, so the slant angle will not become less. For the construction resistance the disc can hold stiffening ribs between the holes, or be designed as compound (doubled) disc. If necessary one engine can maintain the movement of several discs pairs at once, which can be joined with the help of bearings (13). The bearings of every discs pair should be fastened together by traction. Actually, there could be a frame for each discs pair, or one big shared frame.

### BRIEF DESCRIPTION OF THE FIGURES OF THE DRAWINGS

A List of Figures:

FIG. 1 shows the assembled representation of the riddling equipment for champagne;

FIG. 2 shows the side representation of the Equipment;

FIG. 3 and FIG. 4 show the different stages of the operating mode;

FIG. 5a, b shows the case with a bottle with two foreshortening;

FIG. 6 shows the case without a bottle;

FIG. 7 shows the case modification which is designed as a cover;

FIG. 8 shows the disc construction designed for the great number of bottles. For simplicity every disc is shown only with one case with a bottle.

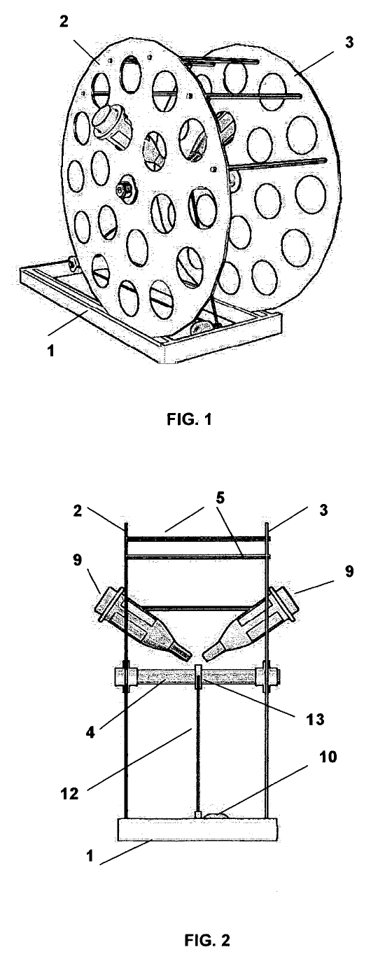

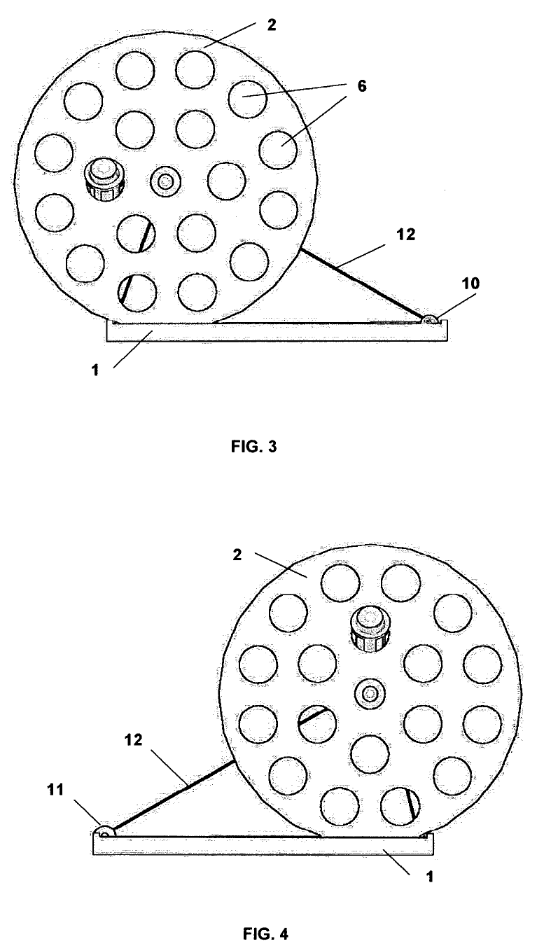

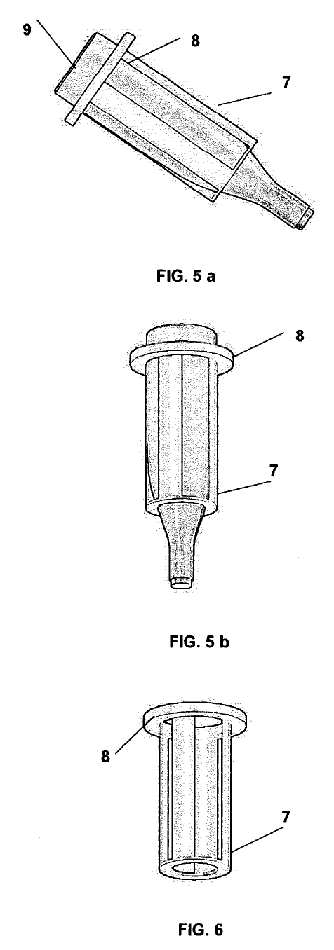

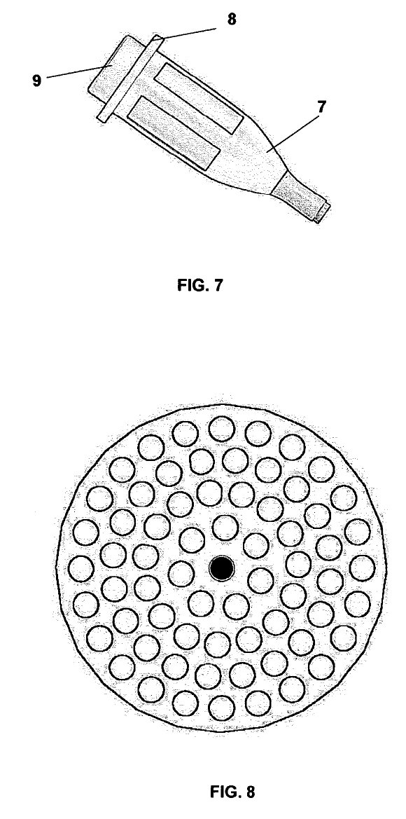

1. The riddling equipment has a frame with a platform FIG. 1-1, which can revolve on the axis and is designed for the container with bottles can be put on it FIG. 1-2, 3, and an operating system, which has placed on the frame engine FIG. 4-11. The equipment has the following peculiarities: the platform FIG. 1-1 is designed as two connected by a rod FIG. 1-4 and placed on the platform discs FIG. 1-2, 3 with holes FIG. 3-6 which are allocated on the discs area evenly, and every hole has a personal container for a bottle FIG. 6 which is designed as an open case with a ring on the open end FIG. 5b-8, FIG. 6-8. The operating system consists of a wire rope cable FIG. 4-12 connected to the rod and the engine's roller what maintains to-and-fro motion of the rod during the roller reversing rotation.
